(19) United States
(12) Patent Application Publication
(10) Pub. No.: US 2005/0161329 A1
(43) Pub. Date: Jul. 28, 2005

(54) Multiplexed capillary electrophoresis systems

(76) Inventors: Katariina Maria Hutterer, Santa Barbara, CA (US); Nels A. Olson, La Jolla, CA (US); Stevan Bogdan Jovanovich, Livermore, CA (US); Thomas M. Armstrong, Santa Clara, CA (US); Dean Burgi, Sunnyvale, CA (US); Vladislav Dolnik, Mountain View, CA (US)

Correspondence Address: Amersham Biosciences Corp;Patent Department, 800 Centennial Avenue, Piscataway, NJ, 08855, US

(21) Appl. No.: 10/511,282

(22) PCT Filed: Apr. 14, 2003
(86) PCT No.: PCT/US03/11454

Related U.S. Application Data
(60) Provisional application No. 60/372,359, filed on Apr. 12, 2002.

(51) Int. Cl. G01N 27/453

(52) U.S. Cl. 204/456; 204/605

(57) ABSTRACT

Multi-capillary systems for high-throughput electrophoretic separation and detection of biomolecules are disclosed. One embodiment of the invention uses galactomannans as a size-sieving matrix for multi-channel electrophoretic separations of biomolecules. Multi-color detection for the simultaneous analysis of controls and standards in the same channels as the samples, and endogenous fluorescence detection are also disclosed. Another embodiment of the invention is a two dimensional system for separation of complex samples, using multiplexed capillary electrophoresis system as the second dimension, with a fraction collection step connecting the two separation steps. The systems allow for separations to be accomplished with a highly parallel manner, or in a two-dimensional format.

### CROSS-REFERENCE TO RELATED APPLICATIONS

This application claims priority to U.S. Provisional Patent Application Ser. No. 60/372,359, filed on Apr. 12, 2002; and is a continuation-in-part of application Ser. No. 09/946,396, filed Sep. 5, 2001, which claims priority to U.S. Provisional Patent Application Ser. No. 60/230,507 and 60/230,508, both filed on Sep. 6, 2000; the entire disclosures of which are incorporated herein by reference.

### FIELD OF THE INVENTION

Instrumentation, and accompanying system for multiplexed separation and detection of proteins, peptides and biomolecules by electrophoresis and related techniques.

### BACKGROUND OF THE INVENTION

Electrophoresis is one of the most widely used separation techniques in the biological sciences. The use of electrophoresis can be performed in any one of several formats, including slab gel electrophoresis, paper electrophoresis, and capillary electrophoresis. While slab gel electrophoresis is the most commonly used of these formats, capillary electrophoresis has been gaining in popularity since its introduction by Bushey and Jorgenson in 1981 (Anal. Chem. 55, 1198-1302). The reason for this is that slab gel electrophoresis is time consuming and suffers from gel-to-gel irreproducibility. On the other hand, capillary electrophoresis (CE) is fast, and lends itself more readily to automation, and is generally more reproducible from lab to lab. Although multiplexed CE separation of nucleic acid molecules is becoming routine, this has not been the case for proteins or other biomolecules, because these are more difficult separations, as there are a greater variety of chemical challenges.

In addition to the existance of several formats of electrophoresis, there exist also a variety of modes, including free zone electrophoresis, gel electrophoresis, and isoelectric focusing, among others. In traditional slab gel electrophoresis, this allows the use two separate separations on the same gel, to improve the number of components that can be resolved from one another (peak capacity). This is done by separating components based on their isoelectric point, using isoelectric focusing, then rotating the gel 90 degrees, and separating the components based on their size, using gel electrophoresis. Other techniques for doing two-dimensional separations have been devised, such as described in U.S. Pat. Nos. 5,496,460 and 5,131,998, and international patents applications WO 02/40983 WO 00/57170.

The detection of biomolecules that have been separated by capillary electrohoresis is an important consideration. Typically, detection is performed optically either by UV absorbance, or by laser induced fluorescence (LIF) of a fluorophore that has been covalently bound to the analyte (called a ‘tag’ or ‘label’), for the purpose of detection. It is often advantageous to add an internal standard or a control to the sample, for simultaneous analysis on the same capillary. This allows one to control for subtle differences in injection and migration from capillary to capillary, and run to run. However, this requires the use of several labels of different wavelengths. The use of a label may cause mobility shifts, which would prevent direct comparison of the sample to the standard or control unless this shift is matched for all of the labels used. In addition to shifting the mobility of analytes, labels may have different number distributions among molecules of the same species. Using labels thus may lead to band broadening during the separation, which in turn may cause a loss in resolution. Further, because of the uncertainty in the number of labels to the number of analyte molecules, labels reduce the ability to quantitate the analytes of interest.

There is a need for highly parallel, easy to use techniques such as multiplexed capillary gel electrophoresis for the separation of proteins, peptides, or other biomolecules. There is also a need for advanced two dimensional separation systems for these molecules in a complex analyte. To increase sensitivity of detection for the highly parallel electrophoresis separations, there is a need to detect endogenous (native) fluorescence of the analytes.

### SUMMARY OF THE INVENTION

Disclosed herein are methods and systems that can be used, among other things, to separate and detect various materials, in a parallel manner. The methods and systems provide high resolution, high sensitivity and high throughput detection of complex biological samples.

In accordance with a first aspect of the invention, there is provided a system and method to perform separation and detection of components within a sample. The system comprises an array of coplanar parallel capillary electrophoresis tubes, each having a first and a second end, said first ends being arranged in a two-dimensional array having a spacing corresponding to that of an array of wells of a microtiter plate; an apparatus arranged to selectively deliver sieving matrix and a selected one of a plurality of liquids to said capillary tube second ends; and a scanning means for exciting and detecting radiation from said array of capillary tubes.

A preferred embodiment of the system utilizes a size-based sieving matrix, such as LPA, dextran, or galactomannans.

Another aspect of the current invention provides a multiplexed capillary electrophoresis system and method for the separation and detection of biomolecules. The system comprises: an array of coplanar parallel capillary electrophoresis tubes, each having a first end and a second end, said first ends being arranged in a two-dimensional array having a spacing corresponding to that of an array of wells of a microtiter plate; an apparatus arranged to selectively deliver sieving matrix and a selected one of a plurality of liquids to said capillary tube second end; and a scanning means for exciting and detecting endogenous fluorescence radiation of the biomolecules from said array of capillary tubes.

A preferred embodiment of the system utilizes a size-based sieving matrix, such as LPA, dextran, or galactomannans. A preferred scanning means includes a laser capable of producing ultraviolet wavelength light, such as a multiplied titanium sapphire laser and harmonic generator.

Another aspect of the current invention provides a method for separating and detecting components in a complex biological sample by two-dimensional separations, comprising: subjecting said sample to a first separation and detection means; collecting fractions into a fraction collection means while said sample is being separated from said first separation means; and subjecting more than one fraction simultaneously to a second separation and detection means, whereas the second separation and detection means is based on a different property of the component biomolecules being separated.

The method can further include the step of dye labeling said complex biological sample before subjecting said sample to the first separation and detection means; or dye labeling said fractions of the complex biological sample after collecting said fractions into said fraction collection means. The method can also include the step of adding controls labeled with mobility-matched dyes to the fractions after said collecting step.

The first separation and detection means consists of HPLC, FPLC, ion exchange chromatography, hydrophobic interaction chromatography, affinity chromatography, isoelectric focusing, isotachophoresis, capillary zone electrophoresis, micellar electrokinetic chromatography, electrochromatography, field flow fractionation, solid phase extraction, liquid phase extraction, or any other standard separation means. Preferably the fraction collection means consists of a microtiter plate. The second separation and detection means is a highly parallel capillary gel electrophoresis system. A preferred sieving matrix in the second separation and detection means is galactomannans or dextran.

Another aspect of the invention provides multi-color detection for the simultaneous analysis of controls and standards in the same channels as the samples.

The foregoing and other objects of the present invention are explained in detail in the drawings herein and the specification set forth herein below.

### BRIEF DESCRIPTION OF THE DRAWINGS

FIG. 1: Size-seiving based protein separation using multiplexed capillary electrophoresis with a galactomannan sieving matrix and LIF detection.

FIG. 2: Matching dye set separation of proteins.

FIG. 3A: Chromatogram of the HPLC dimension as first of two dimensional separation of rat liver proteins.

FIG. 3B: Zoomed view of area enclosed in the rectangle of the chromatogram shown in FIG. 3A.

FIG. 3C: Capillary electrophoresis separation of fraction enclosed in rectangle of the chromatogram shown in FIG. 3B.

FIG. 3D: Zoomed view of area enclosed in rectangle of the electropherogram shown in FIG. 3C.

FIG. 4: IEF-CE separation, the result from one fraction of the IEF dimension is shown as separated by CE.

FIG. 5: Two-color two-dimensional separation of E. coli protein extract separated by HPLC and CGE with a galactomannan sieving matrix.

FIG. 6A: Modified MegaBACE 1000™ instrument with titanium sapphire laser.

FIG. 6B: Modifications of MegaBACE 1000™ for the separation and detection of bioactive molecules using any method for excitation to produce endogenous fluorescence.

FIG. 6C: Detailed view of the detection region of the modified MegaBACE 1000™ system.

FIG. 7: Limit of Detection (LOD) plot for the endogenous fluorescence detector as shown in FIG. 6.

FIG. 8: Protein separation and endogenous fluorescence detection on a 96 capillary instrument as shown in FIG. 6.

### DETAILED DESCRIPTION OF THE INVENTION

The current invention is an instrument and system for the multiplex separation and detection of proteins, peptides, biomolecules and their conjugates, small molecules and their conjugates, and polymers by electrophoresis and related techniques. The system has a plurality of capillaries or channels, of suitable material, such as glass or plastic. Electrophoretic separations are carried out in the capillaries or channels, and detected using laser induced fluorescence (LIF) (either one or two photon processes). The LIF can be of fluorescently labeled molecules or the endogenous fluorescence of molecules.

Multiplex Separation with Galactomannans

One embodiment of the invention relates to multiplexed size-based electrophoretic separation of proteins and other biomolecules. Separation can be achieved by either free zone electrophoresis, or electrophoresis with a sieving matrix, such as linear polyacrylamide (LPA).

In one embodiment, the separation and labeled fluorescence detection of proteins on a 96 capillary instrument is achieved. A multi-capillary electrophoresis system, MegaBACE 1000™ (Amersham Biosciences, Sunnyvale, Calif.), is used in its unaltered form. This instrument has a series of 6 arrays of 16 capillaries each, which couple to a high pressure cell on one side of the array, resulting in the capacity to fill each capillary with viscous matrices. After the capillaries have been filled with fresh matrix, the samples are loaded by electrokinetic means, the array of samples is replaced with buffer, and a high voltage is applied to provide the separation field. Typically, this voltage is in the range of 8-20 kV, although any voltage may be used. As the samples progress down the capillaries, they pass a detection region, in which laser-induced fluoresence detection is accomplished. The LIF detection system of MegaBACE 1000™ has a confocal scanning fluorescence detector, as described in U.S. Pat. No. 5,274,240. This fluorescence detector can collect up to four different spectral channels of data per data acquisition cycle, allowing for the simultaneous analysis of up to four different chemistries per separation channel.

U.S. patent application Ser. No. 09/946,396, which is incorporated herein by reference in its entirety, discloses the process of purification for galctomannans that is used in the instant invention. The weight average molecular mass of the galctomannans used is in the range of 10⁵ and 3×10⁶. Galactomannans having a molecular weight of at least 300,000 are the preferred choice for sieving matrixes. The viscosity and weight average molecular mass of galactomannans can be reduced by the methods of ultrasonic treatment, autoclaving, acid hydrolysis, and basic hydrolysis. The preferred capillary column for protein analysis has an interior cavity filled with a gel composed of 10 g/L galactomannans having a molecular mass of 7.7×10⁵, 50 mM TRIS, 50 mM HEPES, and 4 mM SDS. Separation is performed by introducing an aliquot of sample to the capillary column, and applying an electric field to the capillary column.

Using this method, 96 parallel size-based separations of fluorescently labeled proteins are routinely achieved. Typically, peak capacities are about 50 for each capillary, and all of the components of interest are adequately resolved. In cases where the same separation was performed in all of the capillarires, similar results are seen in all 96 channels. Thus, this method yields high-throughput, reproducible separations of proteins and peptides.

Two Dimensional Separation Using CGE as the Second Dimension

Separations of highly complex samples require high peak capacity. For separations of biologically active molecules the use of two dimensions of separation is often necessary to resolve the large number of components present in mixtures of either biological or synthetic origin. The classic example of this is the well-known art of 2D slab gel electrophoresis, in which one dimension is isoelectric focusing, and the other is size sieving. However, any two separation techniques which have different separation mechanisms may be coupled to provide a better separation.

Another embodiment of the invention, referred to hereafter as the 2D CGE device, provides an apparatus and method for high resolution separation and high sensitivity detection of proteins or other components contained in biological samples, in a high throughput manner.

There is provided a first dimension separation, preferably performed by electrophoretic or chromatographic means. Examples of separation techniques that could precede size sieving include: HPLC, FPLC, ion exchange chromatography, hydrophobic interaction chromatography, isoelectric focusing, electrochromatography, field flow fractionation, solid phase extraction, liquid phase extraction and others. This first dimension separation technique divides the sample into a number of fractions where each fraction may contain one or more components.

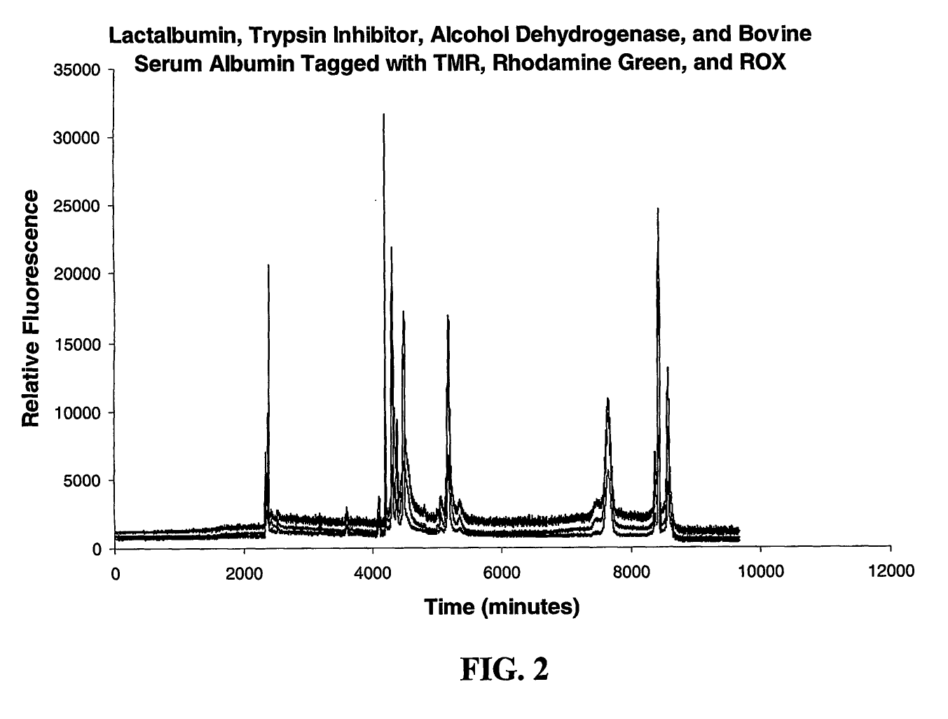

The invention further provides that each fraction is collected into an interface device, such as a microtiter plate. The interface device provides a means for storage of the sample fractions, if desired. An aliquot of each fraction can be used for the second dimension separations, or other subsequent analysis. If whole fractions will be used for the second dimension separation, any needed modification to the sample can be performed in the interface device. Such modifications include any adjustment in solvents (if desired), and labeling of the sample if it is not labeled prior to the first dimension separation. Alternatively, an aliquot of each fraction can be transferred to a similar device, and used for the second dimension analysis, while the remaining aliquots can be used for other analysis, or archiving. Additionally, controls and/or standards can be added to each fraction. The controls and/or standards are each labeled with a dye of a different fluorescent emission wavelength than the dye used to label the samples, but matched in mobility. This allows for a direct comparison between the sample and the control, and for the normalization of migration time for each capillary. Such dyes are readily available, and FIG. 2 shows a separation of four proteins, each labeled with three different dyes. The mobilities for the dyes are very closely matched, so that the peaks for each protein match well.

From the interface device, one or more of the fractions (or an aliquot of the fraction, see above) are simultaneously loaded onto the second-dimension separation device, which further separates the components within each fraction by capillary gel electrophoresis (CGE). This second dimension separation can be simultaneous for all, or for a substantial number of fractions, of the sample being analyzed. In the preferred embodiment, separation is performed with a MegaBACE 1000™ system.

The advantage of performing two dimensional separations using the current system is that the time frame for analysis of the second dimension need not be extremely short compared to the time frame for analysis of the first dimension, as with an integrated 2D device. This allows for greater flexibility in the choice of each dimension, which otherwise would constrain the first dimension to be very slow, to allow for a reasonable separation time for the second dimension, or the second dimension to be extremely fast, which may not always be possible. It also has the distinct advantage over techniques which collect fractions from the first dimension separation, and analyze them in serial, as the total analysis time is greatly reduced, reducing the possibility of sample degradation and increasing throughput.

Multiplex Separation with UV-LIF Detection

The art of fluorescence detection for multi-capillary electrophoresis systems for molecules which fluoresce in the visible spectrum is well established, as exemplified by U.S. Pat. Nos. 5,274,240, 5,498,324 and 5,582,705. However, all of the multi-capillary fluorescence detection systems available to date rely on the use of fluorescent “tags”, which require derivatization of the molecules of interest. The instant invention takes advantage of the endogenous (native) fluorescence of certain molecules, which allows for detection of the molecules without derivitazation, and is a significant improvement in the art of detection, as the derivatization can often adversely affect the separation in a significant manner. We refer to this detection system as the UV-LIF system.

The UV-LIF system consists of a plurality of capillaries, arranged in a coplanar manner, with a confocal scanning fluorescence detector. This invention is capable of detecting endogenous fluorescence for multiple capillaries, using any of several methods including UV and two photon techniques. One such embodiment is described herein, using a titanium sapphire laser and a armonic generator capable of producing wavelengths in the ultraviolet and specialty optics to deliver the laser light in a tight spot, and to efficiently collect the fluorescence emission. Alternatively, one could use single wavelength lasers, such as frequency multiplied gas lasers, frequency multiplied solid state lasers, optically pumped solid state lasers, or multiple wavelength alternative light sources such as mercury-xenon lamps or diodes (should they become available).

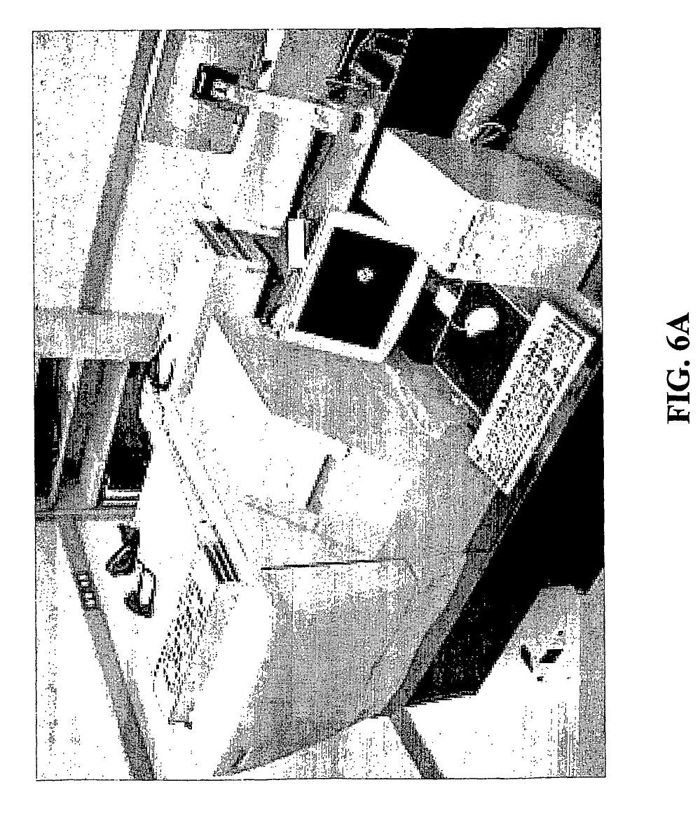

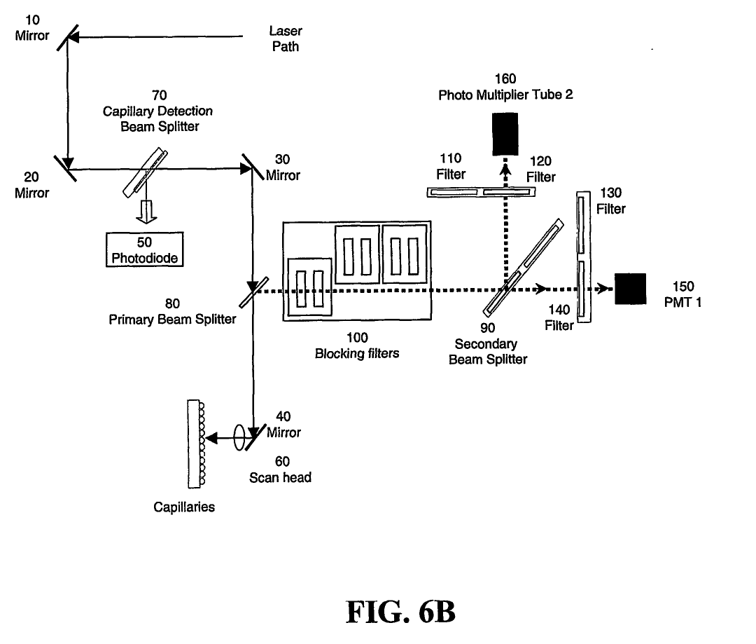

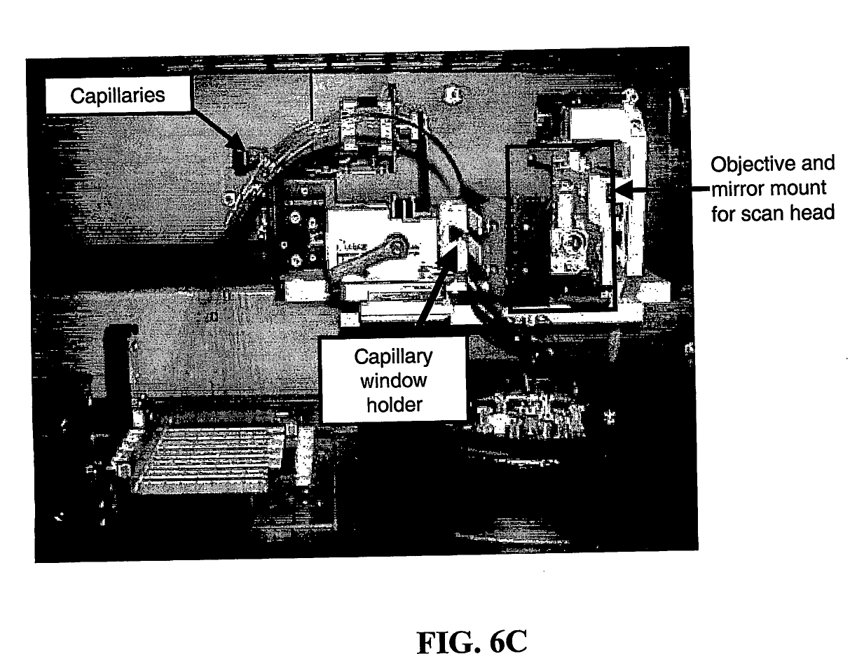

FIG. 6 shows the instrument setup for the invention, namely endogenous fluorescence detection of bioactive molecules during separation. The electrophoresis apparatus used was based on a MegaBACE 1000™ system, which was designed to do gel electrophoresis of DNA. The electrophoresis component of the system consists of arrays of capillaries which are bundled and coupled into reagent tubes on the anode end, and are distributed and coupled into a microtiter plate on the cathode end. The detection system in the MegaBACE 1000™ system is based on U.S. Pat. No. 5,274,240, and the current invention follows a similar optical configuration, but is adapted to allow for UV excitation, reflection, and fluorscent emission. FIG. 6A shows a 96-capillary MegaBACE 1000™ system modified with a detection system of this invention. In this embodiment, a titanium sapphire laser (Spectra-Physics, Mountain View, Calif.) is used for the excitation to replace the argon-ion laser (Spectra-Physics) that is used in the commercial MegaBACE 1000™ detection system. The schematic for the laser induced fluorescence detector optics is shown in FIG. 6B. The implementation of the system for transmitting UV and two photon sources of excitation energy involves the use of enhanced (protected) aluminum mirrors 10, 20, 30, and 40, UV sensitive diodes 50 for the detection of specular reflection during capillary positional registration, synthetic fused silica and sapphire lenses 60, specially patterned reflective beam splitters 70, 80, and 90, and custom kinematic filter holders 100 for laser blocking at multiple wave lengths. These are described in the next four paragraphs.

FIG. 6B presents the optical system for the invention. The solid line represents the incoming laser light, while the dotted line represents the fluorescent emission. The laser is a 1064 nm infrared diode laser (Spectra-Physics,), which is doubled to 532 nm. This beam is then used to pump fluorescence processes in a titanium sapphire (Ti:Sapphire) laser, which can produce a wide range of wavelengths. In this embodiment, the Ti:sapphire is tuned to 840 nm and tripled (using a tripling crystal) to 280 nm. This beam is then reflected off Mirror 1 (enhanced aluminum) (10) and directed to Mirror 2 (enhanced aluminum) (20) of the system. Mirror 2 is movable and allows the laser power to be monitored on the adjacent power monitor before each run. Because the amplitude of the reflected laser light incident on photodiode so is greatest at the center of a capillary, a UV enhanced diode is used to determine where the center of each capillary lies.

Mirror 3 (30) is also an enhanced aluminum mirror for optimal reflectance in the UV. The primary beam splitter (80) before the scanning bench is a pattered, UV enhanced aluminum mirror. It has a non-reflective hole in the aluminum mirror to allow the beam to reach the scan head. The returning beam is larger in diameter and is passed by the reflective area of the beam splitter to the laser blocking filters (100) and eventually to the photo multiplier tubes (150, 160) for detection.

After passing through the primary beam splitter the beam travels to the low-mass scan head where it is reflected (off Mirror 4, enhanced aluminum) to a synthetic fused silica singlet lens (60). This beam induces fluorescence in samples being separated in the capillaries. Fluorescence from the samples in the capillaries is collected by the same lens and transmitted back to the primary beam splitter where it is reflected into the detection area of the optical bench.

FIG. 6C shows the lightweight objective and mirror mount and the scanning area. Reflectors and UV enhanced lenses are necessary for the delivery of laser light to the samples being separated. The capillary window holder and capillaries are designated in this figure.

The following examples are in no way exhaustive and merely represent some of the types separations possible utilizing the instrument and chemistries described.

### EXAMPLE 1

### Protein Separation by Multiplex CGE

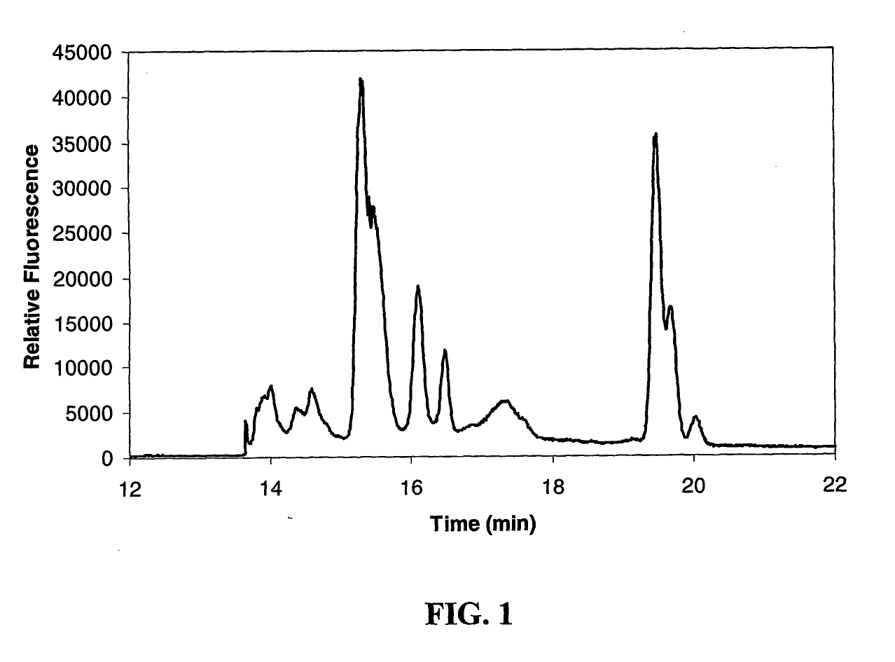

An unmodified MegaBACE 1000™ instrument was used for this separation. The 60 cm long capillaries were coated with linear polyacrylamide, then filled with a separation medium of 1% guaran sieving matrix, in 50 mM Tris, 50 mM HEPES, 4 mM SDS. Fluorescently labeled protein standards (Sigma, catalog number F3401) The labeled proteins were loaded onto the capillary columns by electrophoretic injection, with an injection time of 3 seconds at 10 kV. The protein standards were separated by electrophoresis over a period of 20 minutes at 12 kV. FIG. 1 shows a representative separation.

### EXAMPLE 2

### Two-Dimension Separation of Rat Liver Proteins by HPLC-CGE

In this separation, a MegaBACE 1000™ system was used to perform CGE as the second dimension separation, and an AKTA™ Explorer was used to perform HPLC as the first dimension. Protein samples were prepared from rat liver tissue which had been homogenized with polytrone in a buffer containing 8 M urea, 4%; (w/v) CHAPS, 20 mM TRIS, 10 mg/mL dithiothreitol (DTT), and 17.4 mg/mL phenylmethylsulfonyl floride (PMSF). The samples were incubated for one hour, and then centrifuged to remove the insoluble material.

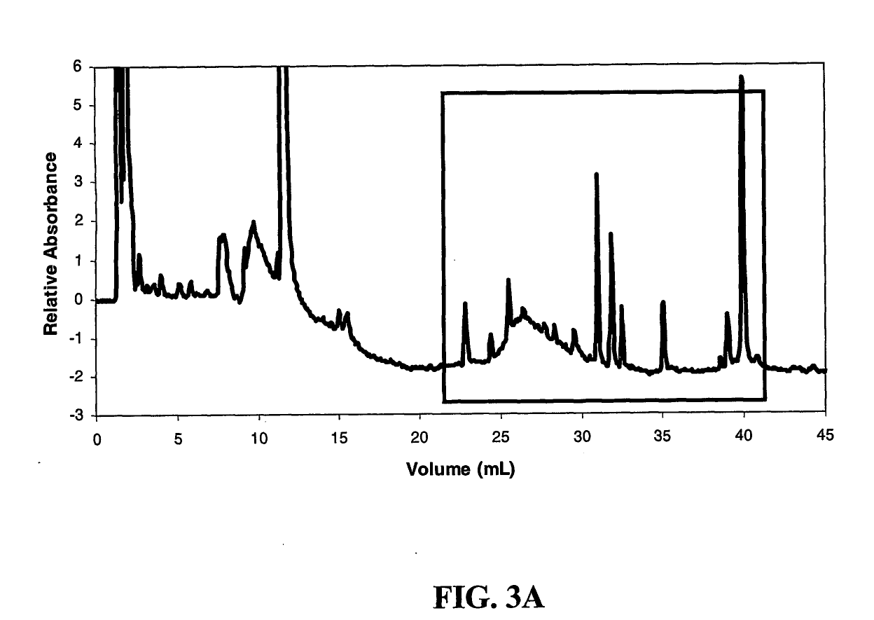

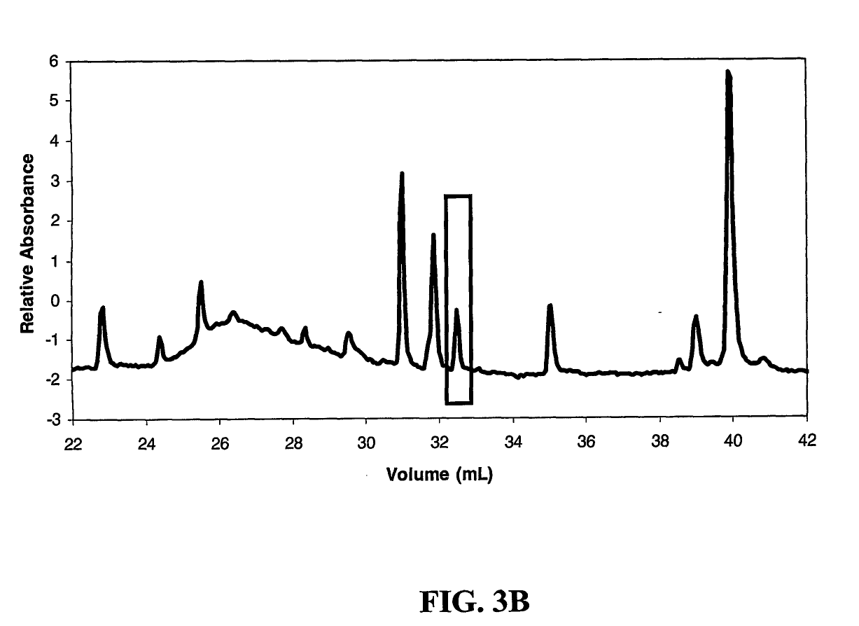

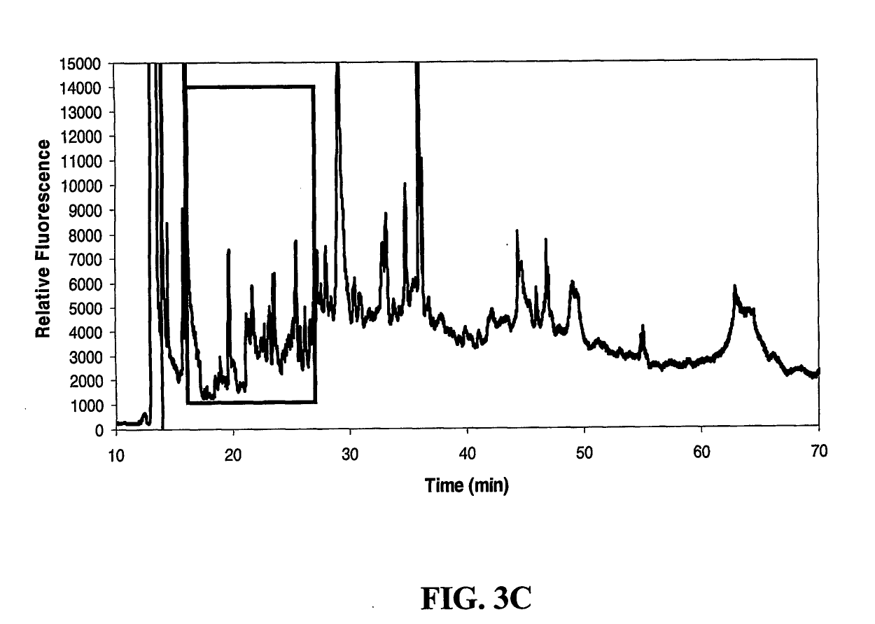

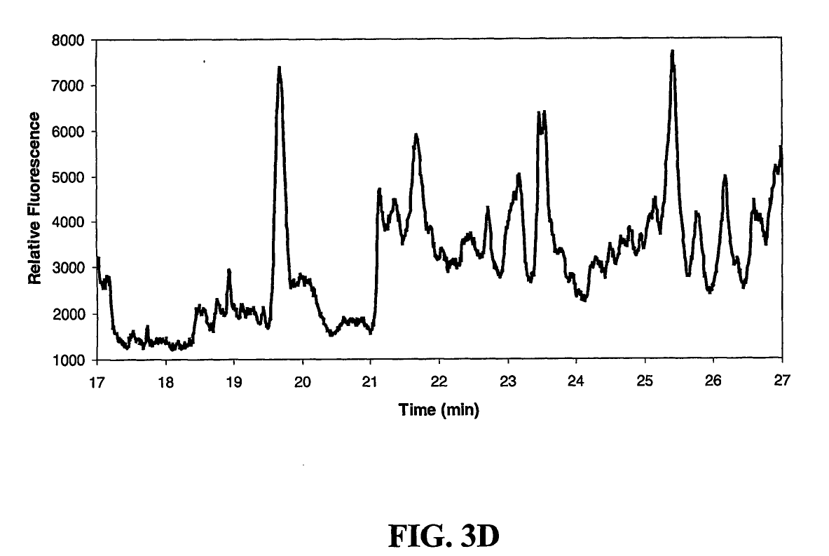

Two buffers were prepared for the separation: buffer A: 10 mM phosphate buffer, and buffer B: 75% acetonitrile in 10 mM phosphate buffer, pH 6.5. The separation was performed on a Sephasil C4, 5 μm ST 4.6/100 mm column. The gradient used was as follows: first, 4 ml 100% A were introduced, then a 34 ml gradient to 100% B, and finally 12 ml 100% B. The effluent was collected into 180 fractions of 200 μl each in a microtiter plate well. These fractions were then dried under reduced pressure, resuspended in 10 mM Tris, pH 8.5 buffer and labeled with the succinimidyl ester of TMR for four hours in the dark. The second dimension CGE separation was performed in parallel on the MegaBACE 1000™ system. The fractions were injected at 2 kV for 40 seconds and separated at 10 kV on 1% Guaran sieving matrix in 50 mM Tris, 50 mM HEPES buffer and 0.1% SDS. FIG. 3A-3D demonstrate the two-dimensional separation of rat liver proteins. The CGE separation of one fraction is shown in FIGS. 3C and 3D.

### EXAMPLE 3

### Two-Dimensional Separation of Rat Liver Proteins by IEF-CGE

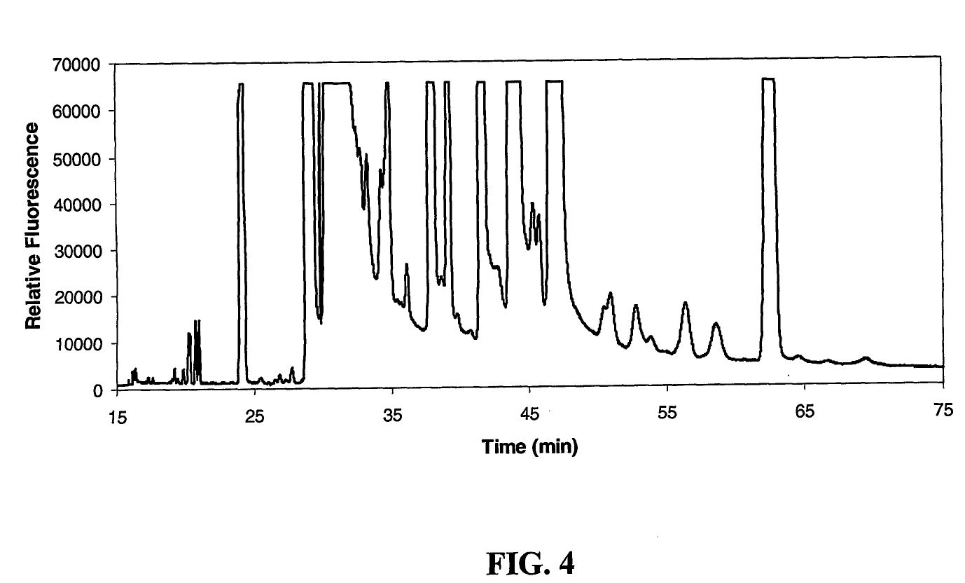

Protein samples were prepared from rat liver tissue as in the previous example. In this separation, isoelectric focusing (IEF) was performed on a drystrip (Amersham Biosciences, part number 17-6002-44, 24 cm Immobiline Drystrip, pH 3-10), in the conventional manner. The strip was then sectioned, ground, and the proteins in each section was extracted into 10 mM Tris 5 mM SDS buffer (pH 8.5). The sections were then analyzed in parallel by size sieving on a MegaBACE 1000™ system (2 kV, 40 second injection, 10 kV run voltage), separated in 15% Dextran matrix with a 10 mM Tris 5 mM SDS buffer (pH 8.5), on 60 cm long capillaries. Shown in FIG. 4 is the CGE separation profile generated from one IEF fraction.

### EXAMPLE 4

### Two-Color Two-Dimensional Separation of E. coli Proteins by HPLC-CGE

In this separation, a MegaBACE 1000™ was used to perform CGE as the second dimension separation, and an AKTA™ Explorer was used to perform HPLC as the first dimension. Proteins were obtained by forming a pellet from E. coli by centrifugation. The pellet was resuspended in 8 M urea, 20 mM TRIS, 4% (w/v) CHAPS with 0.1 mM PMSF. The cell suspension was sonicated in an ice bath until clarified. 100 mg of DTT were added to 10 mL of solution, and the solution was incubated for 15 minutes, and then centrifuged.

Two buffers were prepared for the separation: buffer A: 10 mM phosphate buffer, and buffer B: 75% acetonitrile in 10 mM phosphate buffer, pH 6.5. The separation was performed on a Sephasil C4, 5 μm ST 4.6/100 mm column. The gradient used was as follows: first, 4 ml 100% A were introduced, then a 34 ml gradient to 100% B, and finally 12 ml 100% B.

The effluent was collected into 180 fractions of 200 μl each in a microtiter plate well. These fractions were then dried under reduced pressure, resuspended in 10 microliters of 10 mM Tris, pH 8.5 buffer and labeled with the a 1 microliter of a solution of 0.1 mg/mL of the succinimidyl ester of ROX dissolved in DMSO for four hours in the dark. After four hours, the volume was increased to 100 microliters with a 50 mM Tris-HEPES, 1% SDS buffer. A set of molecular weight size standards were prepared by labeling a solution 1 mg/mL in lactalbumin, trypsin inhibitor, alcohol dehydroginase, and bovine serum albumin with an excess of the succinimidyl ester of rhodamine green dissolved in DMSO for four hours in the dark. The standards were desalted on a Sephadex G-20 column (Amersham Biosciences), diluted 100-fold, and 3 microliters of the size standards were added to each fraction of the sample.

The second dimension CGE separation was performed in parallel on a MegaBACE 1000™ system. The samples were injected at 2 kV for 40 seconds and separated at 10 kV on 1% Guaran sieving matrix in 50 mM Tris, 50 mM HEPES buffer and 01% SDS.

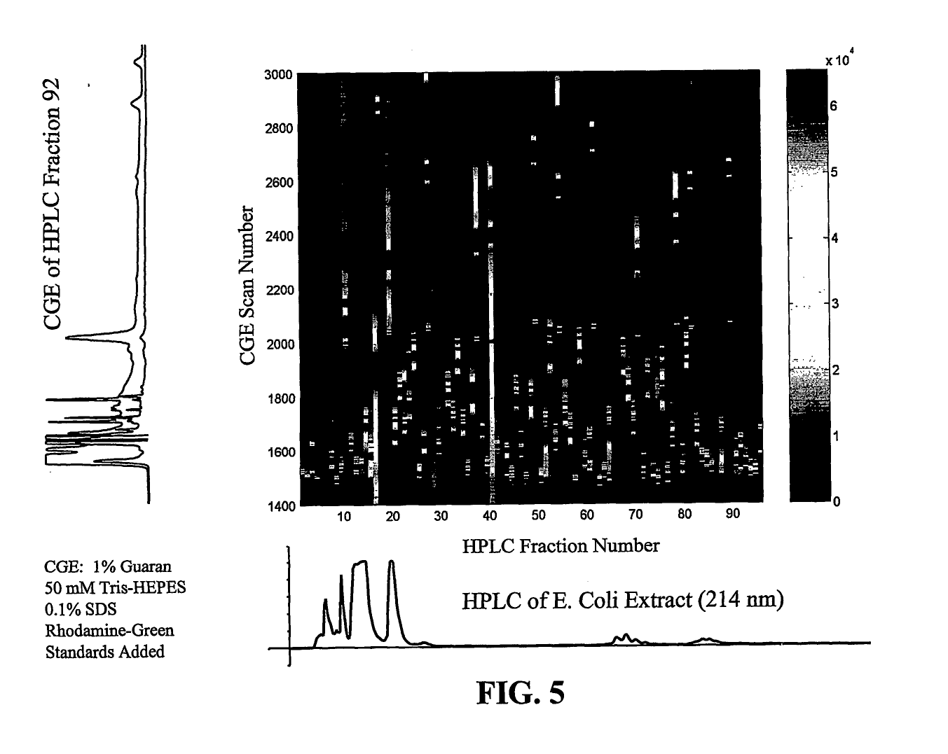

FIG. 5 demonstrates the two-dimensional separation of proteins from the E. coli extract. The trace at the bottom of the page represents the HPLC separation, with UV assorption detection. Because UV assorption detection is less sensitive than LIF detection, not all of the proteins that are present can be seen in this trace. The double trace on the left-hand side of the figure represents the raw data from separation of one of these fractions. Two of the four spectral channels are shown in this trace (the other two have been removed for clarity). The large square block represents the full two-dimensional separation. The bottom axis represents the HPLC separation, with each fraction collected appearing as a different vertical lane. Each parallel CGE separation then proceeds from the bottom to the top of the figure. Time is represented by the scan number. Each scan represents about 1/100^{th} of a minute, so the area shown represents from the 14^{th} until the 30^{th} minute of the CGE separation, or about 16 minutes worth of data. It is clear from this figure that there is much more separation power using the two dimensional separation method of the current invention. It is also clear that data collected in multiple spectral channels will allow for migration time normalization of the sample (by the use of standards) and the amount of each component (by the use of controls).

### EXAMPLE 5

### A Limit of Detection Plot for the Detection of Tryptophan

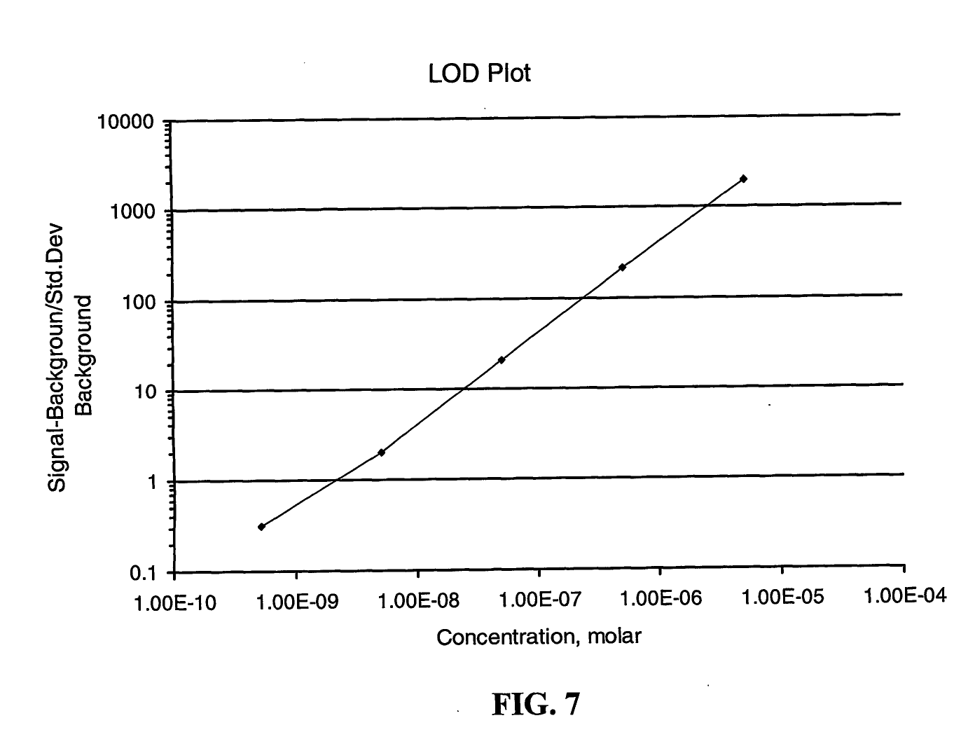

To test the limit of detection (LOD) for the UV-LIF system, we performed the following experiments. Capillaries are mounted in a UV-LIF modified MegaBACE 1000™ system that accepts the endogenous fluorescence detection, as shown in FIG. 6 and related descriptions above. The capillaries were filled with dilute solutions of tryptophan and were scanned at 280 nm excitation. The signal minus the background divided by the standard deviation of the background (S-B/SDB) was calculated, and was compared between concentrations in this plot. The limit of detection is defined at the point where the signal to noise ratio (S-B/SDB) reaches a value of three. In this plot an LOD of 6×10⁻⁹ molar is demonstrated (FIG. 7).

### EXAMPLE 6

### Separation of Proteins Using CGE with Endogenous Fluorescence Detection

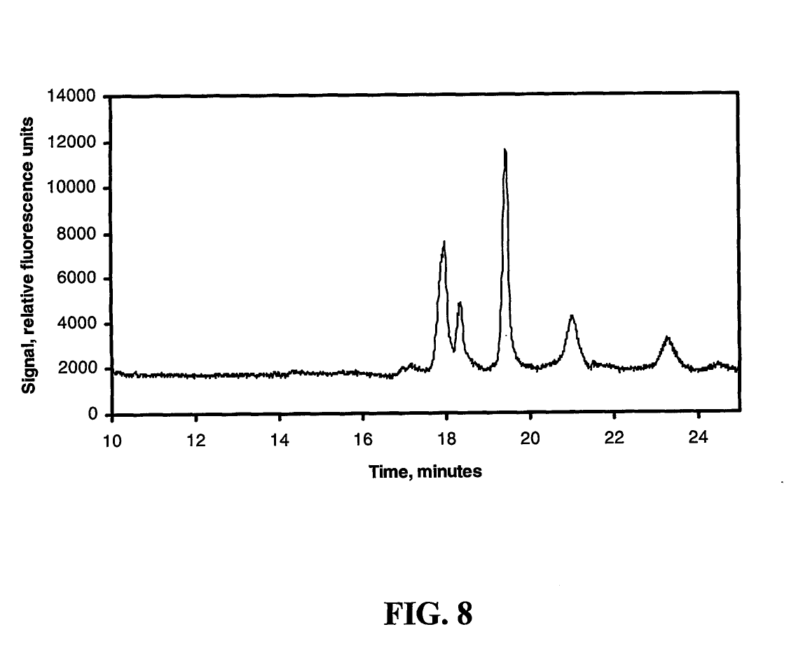

A protein mixture containing 6 proteins was analyzed on an UV-LIF system. To prepare this mixture, 100 uL of a solution containing 5 g/L of each protein was diluted with 10 uL 20% SDS, 10 uL (100 g/L) DTT, 480 uL H₂O to a final volume of 600 ul. The final concentration after dilution of each protein was: insulin 1.7×10⁻⁶ M, α-lactalbumin 7.1×10⁻⁷ M, β-lactoglobulin 5.6×10⁻⁷ M, cabonic anhydrase 3.4×10⁻⁷ M, ovalbumin 2.2×10⁻⁷ M, bovine serum albumin 1.5×10⁻⁷ M. This mixture was aliquoted to 10 uL per well in 16 wells of a 96 well microtiter plate (50 ug total protein per well). This sample was injected at 10 kV for 10 seconds and run for 25 minutes at 10 kV with a run buffer of 50 mM Tris, 50 mM HEPES and 0.1% SDS on a UV-LIF modified MegaBACE 1000™ system as shown in FIG. 6 and described above. The signal to noise ratio (signal minus background over the standard deviation of the background) was 405 for β-lactalbumin. The separation of the above proteins is shown in FIG. 8. Bovine serum albumin was not observed due to insufficient analysis time.

The use of MegaBACE 1000™ and UV-LIF modified MegaBACE 1000™ systems in the 1D and 2D separation of proteins, peptides and other bioactive molecules not only reduces the analysis time; it also offers unparalleled peak capacity. It allows samples, references/controls and standards to be run simultaneously by using the matched dyes. These should allow us to differentiate sample from dosed and un-dosed histories, thus allowing for comparisons in drug development, toxicology, environmental effects and others.

It is apparent that many modifications and variations of the invention as hereinabove set forth may be made without departing from the spirit and scope thereof. The specific embodiments described are given by way of example only, and the invention is limited only by the terms of the appended claims.

1. A multiplexed capillary electrophoresis system for the separation and detection of proteins and peptides, comprising:
(a) an array of coplanar parallel capillary electrophoresis tubes, each having a first and a second end, said first ends being arranged in a two-dimensional array having a spacing corresponding to that of an array of wells of a microtiter plate;
(b) an apparatus arranged to selectively deliver sieving matrix and a selected one of a plurality of liquids to said capillary tube second ends; and
(c) a scanning means for exciting and detecting radiation from said array of capillary tubes.

2. The system of claim 1 wherein said sieving matrix is a size based sieving matrix.

3. The system of claim 2 wherein said sieving matrix includes dextran.

4. The system of claim 2 wherein said sieving matrix includes galactomannans.

5. A multiplexed capillary electrophoresis system for the separation and detection of biomolecules, comprising:
(a) an array of coplanar parallel capillary electrophoresis tubes, each having a first end and a second end, said first ends being arranged in a two-dimensional array having a spacing corresponding to that of an array of wells of a microtiter plate;
(b) an apparatus arranged to selectively deliver sieving matrix and a selected one of a plurality of liquids to said capillary tube second end; and
(c) a scanning means for exciting and detecting endogenous fluorescence radiation of the biomolecules from said array of capillary tubes.

6. The system of claim 5 wherein said scanning means includes a laser capable of producing radiation of an ultraviolet wavelength.

7. The system of claim 6 wherein said laser is a multiplied titanium sapphire laser.

8. The system of claim 5 wherein said sieving matrix is a size based sieving matrix.

9. The system of claim 8 wherein said sieving matrix includes dextran.

10. The system of claim 8 wherein said sieving matrix includes galactomannans.

11. The system of claims 1 wherein the array of coplanar parallel capillary electrophoresis tubes comprises at least 16 capillaries.

12. The system of claims 1 wherein the array of coplanar parallel capillary electrophoresis tubes comprises at least 96 capillaries.

13. The system of claims 1 wherein the array of coplanar parallel capillary electrophoresis tubes comprises at least 384 capillaries.

14. A method of separating and detecting components in a complex biological sample by two dimensional separations, comprising:
(a) subjecting said sample to a first separation and detection means to a plurality of fractions;
(b) collecting said plurality of fractions in a fraction collection means; and
(c) subjecting more than one fraction of said plurality of fractions simultaneously to a second separation and detection means, wherein said second separation and detection means is based on a different property of the component being separated than said first separation and detection means.

15. The method of claim 14, further comprising the step of dye labeling said complex biological sample before subjecting said sample to the first separation and detection means.

16. The method of claim 14, further comprising the step of dye labeling said fractions of the complex biological sample after collecting said fractions into said fraction collection means.

17. The method of claim 14, further comprising the step of adding controls labeled with mobility-matched dyes to the fractions after said collecting step.

18. The method of claim 14, whereas the first separation and detection means consists of HPLC, FPLC, ion exchange chromatography, hydrophobic interaction chromatography, affinity chromatography, isoelectric focusing, isotachophoresis, capillary zone electrophoresis, micellar electrokinetic chromatography, electrochromatography, field flow fractionation, solid phase extraction, liquid phase extraction, or any other standard separation means.

19. The method of claim 14, whereas the second separation and detection means is a highly parallel capillary gel electrophoresis system.

20. The method of claim 19, wherein galactomannans is used as a sieving matrix in the second separation and detection means.

21. The method of claim 19, wherein dextran is used as a sieving matrix in the second separation and detection means.

22. The method of claim 14, whereas said fraction collection means consists of a microtiter plate.
